(19) United States
(12) Patent Application Publication
(10) Pub. No.: US 2008/0159940 A1
(43) Pub. Date: Jul. 3, 2008

(54) High Form Factor Crystalline Zirconium Phosphate, Method for the Preparation Thereof and Use Thereof in a Macromolecular Material

(75) Inventors: Nicole Aupaix, Plaisir (FR); Dominique Dupuis, Crepy-En-Valois (FR)

Correspondence Address: Jean-Louis Seugnet;RHODIA INC, 8 Cedar Brook Drive, CN 7500, Cranbury, NJ, 08512-7500, US

(73) Assignee: RHODIA CHIMIE, Boulogne-Billancourt Cedex (FR)

(21) Appl. No.: 11/630,601

(22) PCT Filed: Jun. 21, 2005
(86) PCT No.: PCT/FR05/01550

§ 371 Date: Sep. 13, 2007

(30) Foreign Application Priority Data
Jun. 22, 2004 (FR) 0406769

(51) Int. Cl. C01B 25/37

(52) U.S. Cl. 423/306; 423/311

(57) ABSTRACT

The zirconium phosphate according to the invention is characterized in that it is crystallized and in that it is comprised of particles that are a maximum 30 nm thick. It is obtained by a method wherein initially phosphoric acid and a zirconium compound are placed in an acid medium, whereupon a precipitate is formed; the precipitate is subsequently separated from the medium thus obtained and is dispersed in a phosphoric acid solution whose concentration is maximum 6 M; the medium thus obtained undergoes thermal treatment at a temperature which is at least equal to the boiling temperature of said medium. Said phosphate can be used in the preparation of compositions based on macromolecular materials in order to improve the properties thereof.

The present invention relates to a crystalline zirconium phosphate with a high form factor, to its process of preparation and to its use in a macromolecular material.

The use is known of inorganic particles to modify the thermomechanical and impermeability properties of macromolecular materials. It is thus possible, for example, to modify the modulus of the materials, the impact strength, the ductility, the dimensional stability, the heat diffraction temperature, the resistance to abrasion or the abrasiveness. In some cases, such as the latexes, the aim is also to improve the characteristics of water uptake and of permeability to water vapor of the materials.

It is known to reinforce macromolecular materials and in particular thermoplastics with platelet particles of nanometric thickness, in particular with particles obtained by exfoliation starting from a compound based on zirconium phosphate with a lamellar structure. The compound with a lamellar structure is treated with an organic expanding agent before incorporation in the material to be reinforced, in order to provide for its exfoliation, which exfoliation is important for improving the thermomechanical properties of the material into which it is introduced.

However, there are disadvantages to the use of exfoliated products. First of all, the process for the preparation of these exfoliated products is relatively complex. It generally results in products which exist in the form of a gel, which, due to the large amount of water in a gel, makes it difficult to incorporate these products in macromolecular materials. Furthermore, as indicated above, their use involves organic expanding agents which can damage the quality of the macromolecular materials in which they are used or can result, here again, in difficulties during the incorporation of the particles or during the forming of the materials. Finally, these agents are generally malodorous, which makes it unpleasant to handle them or which requires large capital expenditures if freedom from the smell is to be obtained.

The object of the invention is to provide a compound which does not exhibit the disadvantages which have just been described.

With this aim, the zirconium phosphate of the invention is characterized in that it is crystalline and in that it is composed of particles with a thickness of at most 30 nm.

The invention also relates to a process for the preparation of such a phosphate which is characterized in that it comprises the following stages:
phosphoric acid and a zirconium compound are brought together in an acidic medium, whereby a precipitate is obtained;
said precipitate is separated from the medium obtained and is dispersed in a phosphoric acid solution with a concentration of at most 6M;
the medium thus obtained is subjected to a heat treatment at a temperature at least equal to the boiling point of said medium.

The phosphate of the invention is prepared by a simple process and it exhibits applicational properties similar to those of the exfoliated products.

Other characteristics, details and advantages of the invention will become even more fully apparent on reading the description which will follow and appended drawings, in which:

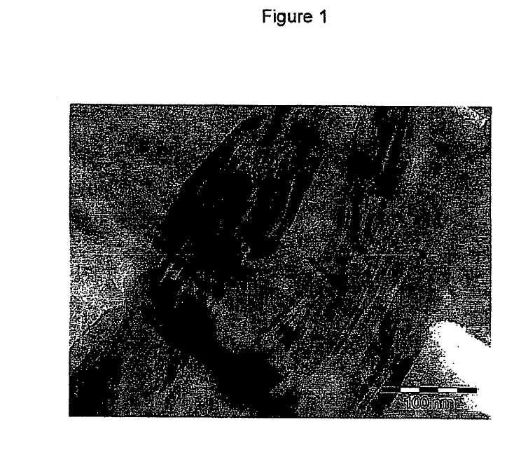

FIG. 1 is a photograph of a product according to the invention obtained by Transmission Electron Microscopy (TEM);

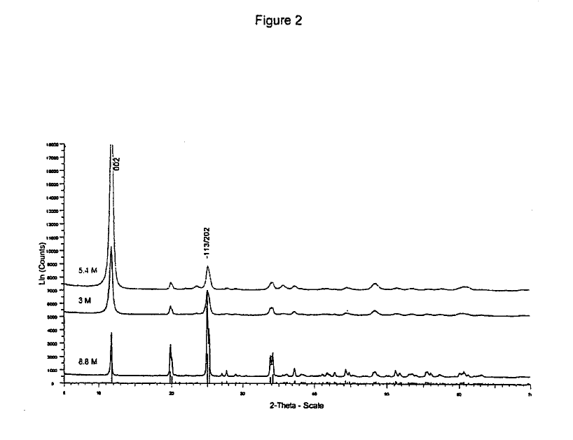

FIG. 2 is an X-ray diagram of products according to the invention and of a comparative product.

The product of the invention is a zirconium phosphate which corresponds more particularly to the chemical formula Zr(HPO₄)₂. It should be noted that some hydrogen atoms can be substituted by sodium atoms. It should also be noted that the zirconium phosphate of the invention can comprise hafnium in an amount by weight which can be of the order of 1 to 2% by weight with respect to the zirconium phosphate. This hafnium generally originates from the starting materials used for the zirconium compounds employed in the process for the preparation of the phosphate of the invention. Finally, this phosphate can be anhydrous or hydrated.

The zirconium can be partially substituted by another tetravalent element, such as titanium, cerium and tin, for example in a proportion which can range up to 0.2 mol % (substituent/zirconium molar ratio).

The first characteristic of the phosphate of the invention is that of being crystalline. This characteristic can be demonstrated by the X-ray diagram of the product. More specifically, it is possible to identify, in the X-ray diagram, at least 2 peaks, the first corresponding to the (002) plane and the second, which is a doublet, corresponding to the (−113) and (202) planes. In addition, the ratio of the area of the peak of the (002) plane to that of the doublet of the (−113) and (202) planes is greater than 1. It is known that this ratio is less than 1 in the case of a known zirconium phosphate with a monoclinic structure. This means that the phosphate of the invention exhibits a crystalline structure which is intermediate between the monoclinic structure and the hexagonal structure.

The other characteristic of the phosphate of the invention is the structure or morphology of the particles constituting it. More specifically, these particles are provided in the form of thin platelets. This morphology can be demonstrated by Scanning Electron Microscopy (SEM). In addition, analysis with a Transmission Electron Microscope (TEM) makes it possible, by a method of measurement by inclusion in a resin, to show that these particles exhibit a thickness of at most 30 nm, more particularly of at most 20 nm, and which can be, for example, between 1 nm and 20 nm. The same thickness values can be obtained from the X-ray diagram by measurement of the size of crystallites perpendicular to the (002) plane.

The platelets constituting the particles are themselves formed of superimposed sheets having a thickness of the order of a few angstroms (5 to 7 Å), it being possible for the space between the sheets to be of the order of 7 to 8 Å. These values can also be obtained by X-ray analysis.

Furthermore, these particles have a size which can be between approximately 0.1 μm and approximately 2 μm, more particularly between 0.2 μm and 0.5 μm, this size being determined by TEM analysis. This size in fact corresponds here to the greatest dimension of the particles, that is to say to their length.

Due to its morphology as thin platelets, the form factor of the particles (length/thickness ratio) is high. It may also be noted here that the high intensity of the peak of the (002) plane with respect to that of the doublet, which characteristic has been mentioned above, reflects the favored growth of the crystallites in this (002) plane and thus the platelet morphology and the high form factor.

Finally, analysis of the TEM photographs shows that a very large majority of the particles are spread out in a satisfactorily horizontal plane or, in other words, only very few particles folded over themselves are seen. This indicates great stiffness of the particles.

The process for the preparation of the phosphate of the invention will now be described.

As indicated above, this process comprises a first stage in which phosphoric acid and a zirconium compound are brought together in an acidic medium.

Mention may be made, as starting zirconium compounds, of zirconium tetrahalides or zirconium oxyhalides, in particular zirconium oxychloride.

Bringing the phosphoric acid and the zirconium compound together results in precipitation.

A simplified balance of the precipitation reaction is, for example, as follows:

2H₃PO₄+ZrOCl₂ [symbol] Zr(H⁺,PO₄³⁻)₂+2HCl

Precipitation is preferably carried out in an aqueous medium. The use of phosphoric acid renders the precipitation medium acidic. The precipitation can advantageously be carried out at an acidic pH, preferably a controlled acidic pH, for example of between 0.5 and 2. Use may be made, to this end, of another acid in addition to phosphoric acid. Mention may be made, by way of example, of hydrochloric acid. It may be noted that the use of hydrofluoric acid is not necessary here.

On conclusion of this first stage of the process, the precipitate is separated from the reaction medium by any suitable means. A washing operation can advantageously be carried out, in particular at least with an aqueous phosphoric acid solution.

The second stage of the process consists in suspending the precipitate in a phosphoric acid solution. This solution should exhibit an acid concentration of at most 6M, more particularly at most 5.5M. This concentration is preferably greater than 2.5M and it can more particularly be between 3M and 4M. In this latter concentration range, the particles are less agglomerated and the solid/liquid separations take place more easily during the implementation of the process.

In a third stage, the dispersion obtained is subjected to a heat treatment. This treatment takes place at a temperature which is at least equal to the boiling point of the medium which undergoes the treatment. The temperature must be sufficiently high to make it possible to obtain the product of the invention with the crystalline structure described above. Generally, but this is not an absolutely essential condition, the temperature at which the heat treatment takes place increases as the acid concentration decreases. It is preferable, for low concentrations of phosphoric acid, for example for those of at most 4M and less than 4M, for this temperature to be greater than the boiling point.

More particularly, this temperature of the heat treatment is at least 120° C. It can, for example, be between 120° C. and 170° C., this upper value not being critical but being essentially limited by economic or equipment constraints.

The heat treatment operation can be carried out under reflux when the temperature at which the treatment takes place is equal to the boiling point of the medium or is situated in the vicinity of the latter. For higher temperatures, the treatment can take place by introducing the liquid suspension into a closed chamber (closed reactor of the autoclave type). Under the temperature conditions given above and in an aqueous medium, it may be specified, by way of illustration, that the pressure in the closed reactor can vary between a value of greater than 1 bar (10⁵ Pa) and 20 bar (2×10⁶ Pa), preferably between 2 bar (2×10⁵ Pa) and 6 bar (6×10⁵ Pa).

The heat treatment is generally carried out under air.

The duration of the heat treatment can vary within wide limits, for example between 1 and 8 hours, preferably between 4 and 5 hours.

On conclusion of the heat treatment, the zirconium phosphate according to the invention is obtained and then exists in the form of a suspension or dispersion in water. However, several alternative forms of the process can be employed at this stage.

The first alternative form consists in separating the solid from the liquid medium by any suitable means. The product is then obtained in a solid form. It is possible to wash the solid obtained and to redisperse it in water in order to obtain a purified suspension.

According to another alternative form, it is possible to transfer the dispersion directly resulting from the heat treatment or the dispersion resulting from the washing operation into a water/ethylene glycol mixture and to optionally remove the water, for example by distillation.

According to a third alternative form, it is possible to add, to the dispersion directly resulting from the heat treatment or to the dispersion resulting from the washing operation, a PET or PEG monomer or oligomer.

In the context of a fourth alternative form, it is possible to add a sodium compound to the dispersion directly resulting from the heat treatment or to the dispersion resulting from the washing operation. This compound can more particularly be sodium hydroxide.

The addition of this sodium compound makes possible partial substitution of the H⁺ protons present in the crystalline phosphate by Na⁺ cations. In the case of the present alternative form, use is made of an amount of the sodium compound such that the Na cation (contributed by the sodium compound)/P atomic ratio is 0.5. A sodium zirconium phosphate pentahydrate of formula ZrNaH(PO₄)₂.5H₂O is thus obtained.

Finally, a fifth alternative form can be employed for the purpose of resulting in a phosphate with an exfoliated structure. This fifth alternative form is similar in its first part to the fourth alternative form insofar as, here again, a sodium compound is added to the dispersion directly resulting from the heat treatment or to the dispersion resulting from the washing operation. However, this alternative form differs from the above in that the Na/P atomic ratio is greater than 0.5 and in that it comprises an additional stage.

This is because, more specifically, use is made of an amount of the sodium compound such that the Na⁺ cation (contributed by the sodium compound)/P atomic ratio is greater than 0.5, preferably at least equal to 0.7 and more preferably still at least 0.8.

The addition of the sodium compound in the amounts given above has the effect of modifying the pH of the starting dispersion up to a value which, generally, is at least 7, more particularly at least 8 and more particularly still at least 9.

The final stage of this fifth alternative form consists in introducing an acid into the medium obtained on conclusion of the preceding stage. The acid is generally an inorganic acid which can be chosen from hydrochloric acid, sulfuric acid, nitric acid and phosphoric acid.

The addition of the acid can result either directly in a gel, which is zirconium phosphate with an exfoliated structure, or in a solid compound, which is obtained in suspension in the reaction medium. In the latter case, this compound is separated from the reaction medium and is then put back into water. After having been put back into water, the formation of a gel is observed, which gel corresponds to the zirconium phosphate with an exfoliated structure.

The way in which this final stage can take place, that is to say direct access to the gel or passing through a solid compound, can depend on the nature of the acid used. It can also depend on the concentration of sodium zirconium phosphate in the dispersion used at the beginning of the stage. By way of example, below a concentration of approximately 10 g/l, the gel can be obtained directly. Thus, the use of hydrochloric acid starting from a dilute dispersion can result directly in the gel.

The acid is generally added so as to bring the pH of the medium down to a value of at most 3, more particularly to a pH of approximately 2 or of at most 2.

The gel can be washed by centrifuging it and then redispersing the product obtained. This operation can be repeated several times. On conclusion of this washing procedure, a gel is obtained which, depending on the number of washing operations carried out, can exhibit a pH of at most 4, for example of between 3 and 4.

The zirconium phosphate with an exfoliated structure obtained by this alternative form is characterized by its purity from organic compounds. Thus, it exhibits a content of organic compounds which is at most 1000 ppm, more particularly at most 500 ppm. This content can more particularly still be at most 300 ppm. The term “organic compounds” is understood to mean any compound comprising carbon and in particular any compound of the expanding agent type mentioned above.

The abovementioned content is expressed as weight of carbon with respect to the zirconium phosphate in the dry state. This content is determined by an analysis which consists in oxidizing the product in the presence of a catalyst in an induction furnace while flushing with oxygen. The carbon is detected by detecting and then integrating the CO₂ peak (infrared quantitative determination). This analysis can be carried out with a device, reference CS-044, from Leco. In this case, the catalyst used can be Lecocel from Leco, ref. 763-266-PL, to which the standards and the samples to be analyzed (approximately 3 g) are added, or the product ref. 502-231 (high purity iron chip accelerator) from the same company (approximately 1.2 g per measurement), to which the samples are added.

The phosphates exhibiting the characteristics given above or obtained by the process as described above can be used in the preparation of compositions based on macromolecular materials. The invention thus also relates to a process for the preparation of such compositions in which use is made, during the preparation of these compositions, of these zirconium phosphates (phosphate with a sheet structure, sodium zirconium phosphate pentahydrate or phosphate with an exfoliated structure).

The macromolecular material can be of different natures: elastomeric, thermoplastic or thermosetting.

The macromolecular material can more particularly be a thermoplastic polymer. Mention may be made, as examples of polymers which may be suitable, of: polylactones, such as poly(pivalolactone), poly(caprolactone) and polymers of the same family; polyurethanes obtained by reaction between diisocyanates, such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′-diphenylmethane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and compounds of the same family, and diols with long linear chains, such as poly(tetramethylene adipate), poly(ethylene adipate), poly(1,4-butylene adipate), poly(ethylene succinate), poly(2,3-butylene succinate), polyether diols and compounds of the same family; polycarbonates, such as poly[methanebis(4-phenyl)carbonate], poly-[1,1-etherbis(4-phenyl)carbonate], poly[diphenylmethanebis(4-phenyl)carbonate], poly[1,1-cyclohexanebis(4-phenyl)carbonate] and polymers of the same family; polysulfones; polyethers; polyketones; polyamides, such as poly(4-aminobutyric acid), poly(hexamethylene adipamide), poly(6-aminohexanoic acid), poly(m-xylylene adipamide), poly(p-xylylene sebacamide), poly(2,2,2-trimethylhexamethylene terephthalamide), poly(metaphenylene isophthalamide), poly(p-phenylene terephthalamide), poly(12-aminododecanoic acid), poly-(11-aminoundecanoic acid) and (co)polymers of the same family; polyesters, such as poly(ethylene azelate), poly(ethylene 1,5-naphthalate), poly(1,4-cyclohexanedimethylene terephthalate), poly(ethylene oxybenzoate), poly(para-hydroxybenzoate), poly(1,4-cyclohexylidenedimethylene terephthalate), polyethylene terephthalate, polybutylene terephthalate and polymers of the same family; poly(arylene oxides), such as poly(2,6-dimethyl-1,4-phenylene oxide), poly(2,6-diphenyl-1,4-phenylene oxide) and polymers of the same family; poly(arylene sulfides), such as poly(phenylene sulfide) and polymers of the same family; polyetherimides; vinyl polymers and their copolymers, such as polyvinyl acetate, polyvinyl alcohol, polyvinyl chloride, polyvinylbutyral, polyvinylidene chloride, ethylene-vinyl acetate copolymers and polymers of the same family; acrylic polymers, polyacrylates and their copolymers, such as polyethyl acrylate, poly(n-butyl acrylate), polymethyl methacrylate, polyethyl methacrylate, poly(n-butyl methacrylate), poly(n-propyl methacrylate), polyacrylamide, polyacrylonitrile, poly(acrylic acid), ethylene-acrylic acid copolymers, ethylene-vinyl alcohol copolymers, acrylonitrile copolymers, methyl methacrylate-styrene copolymers, ethylene-ethyl acrylate copolymers, methacrylate-butadiene-styrene copolymers, ABS and polymers of the same family; polyolefins, such as low density poly(ethylene), poly(propylene), low density chlorinated poly(ethylene), poly(4-methyl-1-pentene), poly(ethylene), poly(styrene) and polymers of the same family; ionomers; poly(epichlorohydrins); poly-(urethane)s, such as polymerization products of diols, such as glycerol, trimethylolpropane, 1,2,6-hexanetriol, sorbitol, pentaerythritol, polyetherpolyols, polyesterpolyols and compounds of the same family, with polyisocyanates, such as 2,4-tolylene diisocyanate, 2,6-tolylene diisocyanate, 4,4′-diphenylmethane diisocyanate, 1,6-hexamethylene diisocyanate, 4,4′-dicyclohexylmethane diisocyanate and compounds of the same family; polysulfones, such as the products of reaction between a sodium salt of 2,2-bis(4-hydroxyphenyl)propane and 4,4′-dichlorodiphenyl sulfone; furan resins, such as poly(furan); cellulose ester plastics, such as cellulose acetate, cellulose acetate butyrate, cellulose propionate and polymers of the same family; silicones, such as poly(dimethylsiloxane), poly(dimethylsiloxane-co-phenylmethylsiloxane) and polymers of the same family; or blends of at least two of the above polymers.

Preference is very particularly given, among these thermoplastic polymers, to polyamides, such as polyamide-6, polyamide-6,6, polyamide-12, polyamide-11, semiaromatic polyamides, PVC, PET, PPO and the blends and the copolymers based on these polymers.

Any method which makes it possible to obtain a dispersion of compounds in a macromolecular material can be employed to use the phosphates of the invention. A first process consists in blending a phosphate in a thermoplastic material in the melt form and in optionally subjecting the blend to high shearing, for example in a twin-screw extrusion device, in order to achieve good dispersion. Another process consists in mixing a phosphate to be dispersed with the monomers in the polymerization medium and then in carrying out the polymerization. Another process consists in blending, with a thermoplastic polymer in the melt form, a concentrated blend of a thermoplastic polymer and of a phosphate.

There is no restriction on the form under which the phosphate is introduced into the medium for the synthesis of the macromolecular material or into the molten thermoplastic macromolecular material. It can, for example, be introduced in the form of a solid powder or in the form of a dispersion in water or in an organic dispersant.

The proportion by weight of the phosphate in the composition based on a macromolecular material is preferably less than or equal to 5%.

The phosphates of the invention can be used more particularly in the case where the macromolecular material is a latex.

The latexes are aqueous dispersions of particles of polymers resulting from conventional processes for the emulsion (co)polymerization of polymerizable organic monomers.

These organic monomers can be chosen, for example, from:
a): alkyl (meth)acrylates, the alkyl part of which preferably comprises from 1 to 18 carbon atoms, in particular methyl acrylate, ethyl acrylate, propyl acrylate, n-butyl acrylate, isobutyl acrylate, amyl acrylate, lauryl acrylate, isoamyl acrylate, (2 2-ethylhexyl)acryl, octyl acrylate, methyl methacrylate, chloroethyl methacrylate, butyl methacrylate, 3,3-dimethylbutyl methacrylate, ethyl methacrylate, isobutyl methacrylate, isopropyl methacrylate, phenyl methacrylate, butyl chloroacrylate, methyl chloroacrylate, ethyl chloroacrylate, isopropyl chloroacrylate or cyclohexyl chloroacrylate;
b): α,β-ethylenically unsaturated esters of monocarboxylic acids, the acid part of which is nonpolymerizable and the unsaturated part of which preferably comprises 2 to 14 carbon atoms and the acid part of which comprises from 2 to 12 carbon atoms, in particular vinyl acetate, vinyl propionate, vinyl butyrate, allyl acetate, vinyl versatate (registered trademark for esters of α-branched acids with 9 to 11 carbon atoms), vinyl laurate, vinyl benzoate, vinyl trimethylacetate, vinyl pivalate and vinyl trichloroacetate;
c): esters and hemiesters of α,β-ethylenically unsaturated polycarboxylic acids having from 4 to 24 carbon atoms, in particular dimethyl fumarate, diethyl maleate, ethyl methyl fumarate or 2-ethylhexyl fumarate;
d): vinyl halides, in particular vinyl chloride, vinyl fluoride, vinylidene chloride or vinylidene fluoride;
e): vinylaromatic compounds preferably exhibiting at most 24 carbon atoms and chosen in particular from styrene, α-methylstyrene, 4-methylstyrene, 2-methylstyrene, 3-methylstyrene, 4-methoxystyrene, 2-hydroxymethylstyrene, 4-ethylstyrene, 4-ethoxystyrene, 3,4-dimethylstyrene, 2-chlorostyrene, chlorostyrene, 4-chloro-3-methylstyrene, 4-tertbutylstyrene, 4-dichlorostyrene, 2,6-dichlorostyrene, 2,5-difluorostyrene and 1-vinylnaphthalene;
f): conjugated aliphatic dienes preferably exhibiting from 3 to 12 carbon atoms, in particular 1,3-butadiene, isoprene and 2-chloro-1,3-butadiene;
g): α,β-ethylenically unsaturated nitriles preferably having from 3 to 6 carbon atoms, such as acrylonitrile and methacrylonitrile. Mention may also be made of homopolymer latexes, in particular poly(vinyl acetate) latexes.

It is also possible to use copolymers of some of the abovementioned main monomers with up to 50% by weight of other monomers with an ionic nature, in particular:
an α,β-ethylenically unsaturated carboxylic acid monomer mentioned above including mono- and polycarboxylic acids (acrylic acid, methacrylic acid, maleic acid, itaconic acid, fumaric acid, and the like),
an ethylenic monomer comprising secondary, tertiary or quaternized amine groups (vinylpyridines, diethylaminoethyl methacrylate, and the like),
a sulfonated ethylenic monomer (vinylsulfonate, styrenesulfonate, and the like),
a zwitterionic ethylenic monomer ((sulfopropyl)-dimethylaminopropyl acrylate),
   or with a nonionic nature, in particular:
amides of unsaturated carboxylic acids (acrylamide, methacrylamide, and the like),
(meth)acrylate esters of polyhydroxypropyl or polyhydroxyethylated alcohols.

Mention may more particularly be made of copolymers of styrene with acrylates and styrene-butadiene copolymers.

Finally, it should be noted here that, in the case of the latexes, the introduction of the phosphate of the invention can also be carried out by simple mixing, with stirring, of the phosphate with the latex.

The incorporation of the zirconium phosphates of the invention in the compositions based on macromolecular materials makes it possible to improve in particular the barrier properties to gases, in particular to water vapor, of the latter and their mechanical properties, such as the temperature stiffness.

The products of the invention can also be used as thickeners in aqueous or organic media to give viscosity effects, in particular in aggressive media, for example highly acidic media. The gelling of detergent products may be thought of.

Examples will now be given.

In these examples, use is made of the following reactants:

Hydrochloric acid (Prolabo, 36%, d=1.19)
Phosphoric acid (Prolabo, 85%, d=1.695)
Deionized water
Zirconium oxychloride (in the powder form) comprising 32.8% of ZrO₂.

An X-ray analysis with a PW1700 diffractometer, equipped with fixed slits and with a copper anode (λₘ=1.5418 Å), is carried out in order to characterize the products.

The operating conditions are from 5° to 70° (2θ degrees) with a step of 0.020° and a time of 1 second per step.

The BET surface shown is that determined by nitrogen adsorption in accordance with ASTM standard D 3663-78 drawn up from the Brunauer-Emmett-Teller method described in “The Journal of the American Chemical Society, 60, 309 (1938)”.

The TEM photographs are obtained by employing the following technique. The product to be analyzed is poured in the powder form into a mixture comprising the compounds necessary to produce an epoxide resin. Polymerization is allowed to take place by raising the temperature of the mixture to 60° C. and by maintaining it at this temperature for 48 hours. Sections with a thickness of 60 to 80 nm are subsequently produced from the block obtained by using a diamond knife ultramicrotome with a water recovery tank. The sections, recovered on copper grids covered with a carbon-coated collodion film, are subsequently examined under an electron microscope.

### EXAMPLE 1

This example describes the preparation of a product according to the invention. This preparation comprises three stages.

### First Stage: Precipitation

An aqueous zirconium oxychloride solution comprising 2.1 mol per liter of ZrO₂ is prepared beforehand.

The following solutions are added at ambient temperature to a stirred 500-ml reactor:

hydrochloric acid: 50 ml
phosphoric acid: 50 ml
deionized water: 150 ml

After stirring the mixture, 140 ml of the 2.1M aqueous zirconium oxychloride solution are added continuously.

Stirring is maintained for 1 hour after the end of the addition of the zirconium oxychloride solution.

### Second Stage: Washing

After removing the aqueous mother liquors, the precipitate is washed with 1.2 l of 20 g/l H₃PO₄ and then with 4 liters of deionized water. A precipitate based on zirconium phosphate is obtained. Drying is carried out at 50° C. for 15 hours and approximately 90 g of product are recovered.

### Third Stage: Crystallization

This third stage makes it possible to obtain a product according to the invention.

A portion of the above precipitate (60 g) is dispersed in 230.6 g of 85% phosphoric acid and 524.9 g of water (i.e, a concentration of acid of 3 mol/liter) and the dispersion thus obtained is transferred into a 1-liter autoclave and then heated to a temperature of 150° C. This temperature is maintained for 5 hours.

The dispersion obtained is washed with deionized water. The cake resulting from the final centrifuging is redispersed so as to obtain a solids content of approximately 10%. The pH of the dispersion is 2.6.

A dispersion of a crystalline compound based on zirconium phosphate according to the invention is obtained, the characteristics of which are as follows.

Analysis using a transmission electron microscope (TEM) demonstrates particles with a size of between 150 and 400 nm.

X-ray analysis indicates, in particular, by the high intensity of the peak of the (002) plane with respect to that of the doublet of the (−113) and (202) planes, favored growth of the particles in this (002) plane and thus the platelet form.

The thickness of the particle measured perpendicular to the (002) plane is 18 nm. The distance measured between the constituent sheets of the platelets is 7.5 Å.

The solids content is 10.4%.

The specific surface, measured by the BET method, is 37 m²/g.

FIG. 1 is a photograph of the product according to the example obtained by TEM.

### EXAMPLE 2

The preparation is carried out as in example 1 and with the same reactants for the first two stages.

The final crystallization stage is subsequently carried out in the following way.

The cake resulting from the washing stage is dispersed in 700 g of 85% phosphoric acid and 588 g of water (i.e., a concentration of acid of 5.4 mol/liter) and the dispersion thus obtained is transferred into a 2-liter reactor and then heated to a temperature of 105° C. This temperature is maintained for 5 hours.

The dispersion obtained is washed with deionized water. The cake resulting from the final centrifuging is redispersed so as to obtain a solids content of 158%. The pH of the dispersion is 3 and the conductivity is 0.28 m.S/cm.

A dispersion of a crystalline compound based on zirconium phosphate according to the invention is obtained, the characteristics of which are as follows.

The thickness of the platelet constituting the particle is 15 nm. The distance measured between the constituent sheets of the platelets is 7.5 Å.

The TEM analysis demonstrates particles of hexagonal shape with a size of between 150 and 500 nm approximately.

### COMPARATIVE EXAMPLE 3

This example describes a preparation process in which the preparation is not carried out according to the conditions of the invention as regards the concentration of phosphoric acid during the final stage.

The preparation is carried out as in example 1 and with the same reactants for the first two stages.

The final crystallization stage is subsequently carried out in the following way.

96 g of the cake resulting from the washing stage are dispersed in 1 liter of 8.8M aqueous phosphoric acid solution and the dispersion thus obtained is transferred into a 2-liter reactor and then heated to 114° C. This temperature is maintained for 5 hours.

The dispersion obtained is washed until a conductivity of less than 1 mS (supernatant) is obtained. The cake resulting from the final centrifuging is redispersed so as to obtain a solids content in the region of 20%. The pH of the dispersion is 2.5.

A dispersion of a crystalline compound based on zirconium phosphate according to the invention is obtained, the characteristics of which are as follows.

The TEM analysis demonstrates particles with a size of between 100 and 200 nm and with a mean size of 140 nm. The thickness of the platelet constituting the particle is 50 nm. The distance measured between the constituent sheets of the platelets is 7.5 Å.

The X-ray diagram shows a dissociation of the peaks of the (−113) and (202) planes and the area of the peak of the (002) plane is less than the total area of the peaks of the (−113) and (202) planes.

The solids content is 18.1% (by weight).

FIG. 2 gives the X-ray diagrams of the products according to examples 1, 2 and 3 which correspond respectively to the curves with the references 3M, 5M and 8.8M.

### EXAMPLE 4

This example describes the use of a product of the invention in a polymer (PET).

The following are introduced into a 7.5-liter polymerization reactor which makes it possible to obtain approximately 3 kg of polymer by polycondensation and which is equipped with a stirrer, the drive torque of which is monitored in order to follow the viscosity of the reaction medium, with a distillation column, in order to remove the water formed during the esterification and excess ethylene glycol, and with a direct vacuum line for the polycondensation stage:

2854.5 g of terephthalic acid
67.2 g of isophthalic acid
1309.0 g of ethylene glycol
33.79 g of the zirconium phosphate in the form of a dispersion in water as obtained on conclusion of the process described in example 1.

After purging with nitrogen, the reaction medium is heated to 275° C. with stirring and under an absolute pressure of 6.6 bar.

The esterification time is 60 minutes. The pressure is subsequently brought back to atmospheric pressure in 20 minutes.

An antimony oxide solution is introduced into the reaction medium.

The pressure is maintained at atmospheric pressure for 20 minutes, before placing under gradual vacuum from 1 bar to less than 1 mm of mercury in 90 minutes.

The reaction mass is brought to 285° C. when the pressure falls below 1 mm of mercury.

The polycondensation time is defined as the time necessary to achieve the targeted level of viscosity starting from the moment at which the pressure is less than 1 mm of mercury.

Once the level of viscosity is reached, stirring is halted and the reactor is placed under a pressure of 3 bar. The polymer obtained is cast through a die to produce a lace which is cut up in the form of granules.

The final characteristics of the PET are given below:

TABLE 1

| | |
|---|---|
| Level of ash | 0.9 |
| Viscosity index | 77 |
| Coloration | |
| L* | 70 |
| a* | 1.9 |
| b* | 9 |

The characteristics which appear in table 1 were measured in the following way:

Viscosity index (in ml/g): measurement according to ISO standard 1628/5: measurement in a 0.5% solution of the composition in a 50/50 by weight phenol/orthodichlorobenzene mixture at 25° C. The concentration of polymer used for the calculation of the viscosity index is the true concentration of polymer, taking into account the level of particles present in the composition.

Coloration according to the CIE lab system: measurement of L*, a* and b*.

In order to confirm the processibility and the appearance of a preform obtained with the material of this example, the polymer was injected on an LX 160T device having a screw of 42 mm with a double cavity mold.

The preform obtained is transparent.

### EXAMPLE 5

This example describes the use of a product of the invention in another polymer of polyamide type.

Two polyamides 6 having a viscosity index respectively of 134 ml/g and 216 ml/g, measured in formic acid (ISO standard EN 307), are synthesized from caprolactam according to a conventional process. The polyamides 6 are referred to as materials A and A′. The granules obtained are referred to as granules A and A′.

Two polyamides 6 having a viscosity index of 130 ml/g and 210 ml/g, measured in formic acid (ISO standard EN 307), are also synthesized from caprolactam according to a conventional process while introducing, into the polymerization medium, an aqueous dispersion of zirconium phosphate according to the invention, this dispersion having been obtained on conclusion of the process described in example 1. 2% by weight of zirconium phosphate are thus introduced with respect to the total weight of the polyamide.

After polymerization, the various polymers are formed into granules. The granules B originate from the polyamide 6 with a viscosity index of 130 ml/g, material B. The granules C originate from the polyamide 6 with a viscosity index of 210 ml/g, material C. The granules are washed in order to remove the residual caprolactam. For this purpose, the granules are immersed in boiling water for two times 8 hours and are then dried under low vacuum (<0.5 mbar) at 110° C. for 16 hours.

Test specimens are manufactured from the granules A and B. The test specimens have a width of 10 mm, a length of 80 mm and a thickness of 4 mm. The test specimens are conditioned at 28° C. and at 0% relative humidity.

Various tests were carried out on the test specimens according to the measurement methods indicated below in order to determine the mechanical properties of the materials:
the tensile modulus is measured on a Zwick Z020 device, load cell: 20 kN, and a distance between jaws of 400 mm. The measurements carried out are presented in table 2 below.

TABLE 2

| | Tensile modulus | Yield stress |
|---|---|---|
| Samples | (MPa) | (MPa) |
| Material A | 2383 | 78.4 |
| (PA 6) | | |
| Material B | 3091 | 80.7 |

It is seen that the material B, which corresponds to a polymer comprising product according to the invention as filler, exhibits improved mechanical properties.

The polymer granules obtained above are formed by extrusion on a device with the CMP trademark.

The characteristics of the processing are as follows:
temperature of the extruder: between 260 and 290° C.
screw speed: 36 rpm
motor torque: 8-10 amperes
variable draw rate (film thicknesses between 50 and 70 μm)

Several films are obtained having a thickness of 50 to 70 μm.

The films are conditioned at 23° C. for 48 hours, the RH (relative humidity) ranging from 0% to 50%, before being subjected to the determination of their oxygen permeability according to the process described below:

The oxygen transmission coefficient is measured according to ASTM standard D3985 under the following specific conditions:

Measurement conditions:
Temperature: 23° C.
Humidity: 0%, 50% RH
Measurements with 100% oxygen on 3 test specimens of 0.5 dm²
Stabilization time: 24 h
Measurement device: Oxtran 2/20

TABLE 3

| | Granules A′ | |
|---|---|---|
| Starting granules | (PA 6) | Granules C |
| O₂ permeability - 0% RH | 0.96 | 0.37 |
| (cm³ · mm/m² · 24 h · bar) | | |
| O₂ permeability - 50% RH | 0.6 | 0.3 |
| (cm³ · mm/m² · 24 h · bar) | | |

It is seen that the films obtained from a polymer comprising a product according to the invention have improved permeability properties.

### EXAMPLE 6

This example relates to the use of a product of the invention in a polymer in the latex form.

100 g of a latex formed of poly(vinylidene chloride) Diofan A232® (solids content: 46%) are mixed with 3.2 g of an 8.7% zirconium phosphate suspension as obtained by the process described in example 2. The mixture is stirred for 1 hour, then approximately 2 ml of the mixture are withdrawn and deposited on a glass sheet, and a film with a thickness of 150 μm is produced using a film drawer. This film, after drying at 25° C. for 24 hours, is transparent.

1-12. (canceled)

13. A zirconium phosphate, being crystalline and composed of particles with a thickness of at most 30 nm.

14. The zirconium phosphate as claimed in claim 13, wherein it the thickness is of at most 20 nm.

15. The zirconium phosphate as claimed in claim 13, having a X-ray diagram exhibiting 2 peaks, the first corresponding to the (002) plane and the second, which is a doublet, corresponding to the (−113) and (202) planes, and having a ratio of the area of the peak of the (002) plane to that of the doublet of the (−113) and (202) planes greater than 1.

16. The zirconium phosphate as claimed in claim 13, wherein the particles have a size of between 0.1 μm and 2 μm.

17. A process for the preparation of a zirconium phosphate as defined in claim 13, comprising the following stages of:
a) bringing together phosphoric acid and a zirconium compound together in an acidic medium to obtain a precipitate;
b) separating said precipitate from the medium so obtained in stage a) and dispersing same in a phosphoric acid solution with a concentration of at most 6M;
c) subjecting the medium thus obtained in stage b) to a heat treatment at a temperature at least equal to the boiling point of said medium; and
d) recovering the zirconium phosphate precipitate.

18. The process as claimed in claim 17, wherein the heat treatment of stage c) is carried out at a temperature of at least 120° C.

19. The process as claimed in claim 17, wherein the precipitate obtained in stage d) is dispersed in a phosphoric acid solution with a concentration of between 3M and 4M.

20. The process as claimed in claim 17, wherein the zirconium compound of stage a) is an oxychloride.

21. The process as claimed in claim 17, wherein the acidic medium of stage a) is formed with hydrochloric acid.

22. A process for the preparation of a sodium zirconium phosphate pentahydrate, comprising the steps of:
a) bringing together phosphoric acid and a zirconium compound in an acidic medium, to obtain a precipitate;
b) is separating said precipitate from the medium obtained and dispersing same in a phosphoric acid solution with a concentration of at most 6M;
c) subjecting the medium thus obtained in stage b) to a heat treatment at a temperature at least equal to the boiling point of said medium;
d) adding a sodium compound to the dispersion directly resulting from the abovementioned heat treatment of stage c) or to this dispersion after washing in an amount such that the Na⁺ cation (contributed by the sodium compound)/P atomic ratio is 0.5; and
e) recovering the zirconium phosphate precipitate.

23. A process for the preparation of a zirconium phosphate with an exfoliated structure, comprising the following stages of:
a) bringing together phosphoric acid and a zirconium compound in an acidic medium, whereby a precipitate is obtained;
b) separating said precipitate from the medium obtained in stage a) and dispersing same in a phosphoric acid solution with a concentration of at most 6M;
c) subjecting the medium thus obtained in stage b) to a heat treatment at a temperature at least equal to the boiling point of said medium;
d) adding a sodium compound to the dispersion directly resulting from the abovementioned heat treatment of stage c) or to this dispersion after washing in an amount such that the Na⁺ cation (contributed by the sodium compound)/P atomic ratio is greater than 0.5, optionally at least equal to 0.7;
e) subsequently adding an acid to obtain either a gel or a solid compound, the latter being put back into water and giving a gel; and
e) recovering the zirconium phosphate gel.
